(19) United States
(12) Patent Application Publication
(10) Pub. No.: US 2012/0167015 A1
(43) Pub. Date: Jun. 28, 2012

(54) PROVIDING VISUALIZATION OF SYSTEM LANDSCAPES

(75) Inventor: Christian Martick, Berlin (DE)

(73) Assignee: SAP AG, Walldorf (DE)

(21) Appl. No.: 12/976,670

(22) Filed: Dec. 22, 2010

(51) Int. Cl. G06F 3/048

(52) U.S. Cl. 715/853

(57) ABSTRACT

One or more processors may provide visual representations of a system landscape. A first visual representation of the system may be displayed, the first visual representation providing a first level of detail of at least one first system component. An indication from a user to display a second visual representation of the system may be received, and the processor may determine a second level of detail of the system based on the received indication. Data associated with the second level of detail of the system may be identified, and the second visual representation of the system may be displayed, the second visual representation of the system including the data associated with the second level of detail of the system.

### TECHNICAL FIELD

The present disclosure relates to software, computer systems, and computer implemented methods for interactive visualization of system landscapes.

### BACKGROUND

Information technology (IT) system landscapes tend to be large, complex and interconnected through various sorts of relations and dependencies. The term “system” may be understood as a technical ‘integrated whole’ software, hardware, or combined system that can be seen as an elementary part of an IT operation. The system itself might consist of several sub-systems that may also be understood as a technical integrated whole. Therefore, they themselves can constitute landscapes and have relations to other systems or subsystems. A system landscape can be understood as a set of systems (and/or subsystems) grouped by any number of (meaningful) properties with an arbitrary number of relations to one each other. A relation (or system relation) is a property or predicate assigned to any tuple of systems (including, for example, reflexive tuples).

### SUMMARY

A computer-implemented method, which may be performed by one or more processors, for providing visual representations of a system may include displaying a first visual representation of the system, the first visual representation providing a first level of detail of at least one first system component. An indication to display a second visual representation of the system may be received from a user. The method may also include determining, by the one or more processors, a second level of detail of the system based on the received indication, and identifying data associated with the second level of detail of the system. The second visual representation of the system may be displayed. The second visual representation of the system may include the data associated with the second level of detail of the system.

A computer program product for providing visual representations of a system, which may be tangibly embodied on a non-transient computer readable medium and storing instructions operable when executed by a hardware processor, may display a first visual representation of the system, the first visual representation providing a first level of detail of at least one first system component. The computer program product may be operable to receive an indication to display a second visual representation of the system. In addition, the computer program product may identify a second level of detail of the system based on the received indication and identify data associated with the second level of detail of the system. Further, the computer program product may display the second visual representation of the system, where the second visual representation of the system including the data associated with the second level of detail of the system.

A system for providing landscape visualization about a computer architecture landscape may include a memory for storing instructions and computer architecture landscape visualization data. The computer architecture landscape organized into a hierarchy having a plurality of hierarchical tiers including a root level tier and at least one sub-level tier. The system may also include at least one hardware processor, operable to execute instructions. Such instructions may include storing computer architecture landscape visualization data, where the computer architecture landscape visualization data including data associated with the root level tier and the at least one sub-level tier. The system may receive a request from a client device to provide the landscape visualization of at least one of the plurality of tiers of the computer architecture hierarchy, and identify, based on the received request, the at least one of the plurality of tiers of the computer architecture hierarchy. The system may also identify a set of the computer architecture landscape visualization data for the at least one of the plurality of tiers; and provide the set of the computer architecture landscape visualization data to the client device.

In certain embodiments, the first visual representation of the system components is a two-dimensional graphical representation of the system components.

In some implementations, displaying the second visual representation of the system includes displaying at least one second system component, the at least one second system component associated with the data associated with the second level of detail of the system.

In some instances, data associated with the second level of detail for the system components may be received from a remote server.

A graphical transitioning between the first visual representation and the second visual representation may also be included in some implementations, the graphical transitioning being based on a predefined set of rules associated with the received indication. In some embodiments, the graphical transitioning between the first visual representation and the second visual representation is based on a hierarchical distance between the at least one first system component and the at least one second system component. In some instances, the transitioning between the first visual representation and the second visual representation is based on a first color value associated with the first visual representation and a second color value associated with the second visual representation.

In some implementations, the first and second color values each include a range of values, each of the range of values representing a relative opacity of a color, and wherein the graphical transitioning between the first visual representation and the second visual representation includes calculating the first color value for the first visual representation based on a hierarchical distance between the at least one first system components and the at least one second system components. In some implementations, the color value is a function of the relative distance between hierarchical levels of the system. In certain embodiments, the color value may result in a maximum color opacity at a root level of the landscape hierarchy. The color value may result in a less than maximum color opacity.

In some embodiments, an indication may be received from the user to display the second visual representation of the system, which includes receiving an input from a user interface.

In some implementations, the set of the computer architecture landscape visualization data may be an interactive graphical representation of the at least one of the plurality of tiers of the computer architecture landscape. The interactive graphical representation of the at least one of the plurality of tiers of the computer architecture landscape may be identified based on an input provided by the client device.

In some implementations, relationships between the root level and the one or more sub-levels of the tiered hierarchy system may be stored and identified.

While generally described as computer implemented software embodied on tangible media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 illustrates an example environment for providing an interactive system landscape visualization.

FIG. 2 is a schematic representation of an example system landscape organized in a subsystem hierarchy.

FIG. 3 is a schematic representation of an example device for providing a user interface for an interactive system landscape visualization.

FIG. 4 is a swim-lane flowchart of an example method for providing an interactive system landscape visualization.

FIG. 5A is a schematic representation of an example low detail level system landscape visualization.

FIG. 5B is a screenshot of an example implementation of a low detail level system landscape visualization.

FIG. 6A is a schematic representation of an example intermediate detail level system landscape visualization.

FIG. 6B is a screenshot of an example implementation of an intermediate detail level system landscape visualization.

FIG. 7A is a schematic representation of an example high detail level system landscape visualization.

FIG. 7B is a screenshot of an example implementation of a high detail level system landscape visualization.

FIG. 8 is a screenshot of an example implementation of a high detail level system landscape visualization.

### DETAILED DESCRIPTION

This disclosure generally describes software, computer-implemented methods, and systems relating to providing an interactive system landscape visualization. Modern IT system landscapes tend to be large, complex and interconnected through various sorts of relations and dependencies. It is advantageous to provide an interactive visualization of such a landscape in a computer graphics context with respect to optimal information presentation for the end user. The present disclosure relates to allowing a user to view a system landscape graphically, and interact with the graphical representation of the landscape. The system landscape can provide the user with a graphical presentation of the relationships and interconnectivity of the systems and/or subsystems that make up the landscape. The visualization of the landscape may be based on human perceptions, where objects increase in their visual detail when one focuses more on that object (e.g., when the object-view-distance decreases). The present disclosure is directed, in part, to a translation of that human perception to a graphical user interface metaphor for visualizing the system landscape.

A system visualization provides a graphical representation of a system. It may be advantageous to provide a system visualization to allow a user, such as an IT professional, to monitor the system for a variety of different reasons. Moreover, it would be advantageous to provide a system landscape visualization, which would provide a user with a graphical representation of a set of systems, their properties, and relations. The interactive visualization may respond by reorganizing the displayed information depending on the provided input to display varying degrees of detail about the system or system landscape. For example, because systems and subsystems may be interconnected by hierarchical relationships, an interactive visualization provides a controllable view of the landscape, responsive to inputs from the user, to allow the user to view different aspects and tiers of the landscape while also visualizing the interconnectivity of the system components in a single hierarchal tier or across different tiers.

Furthermore, the human perception metaphor may be used to hide unnecessary complexity, make relations and dependencies clearer, and adjust the visible information according to the needs of the user based on implementation specifics and user determined filter criteria. Similarly, the visualization of extraneous system information can be hidden or partially hidden, depending on user implementation, to provide varying degrees of system component and system interconnectivity information.

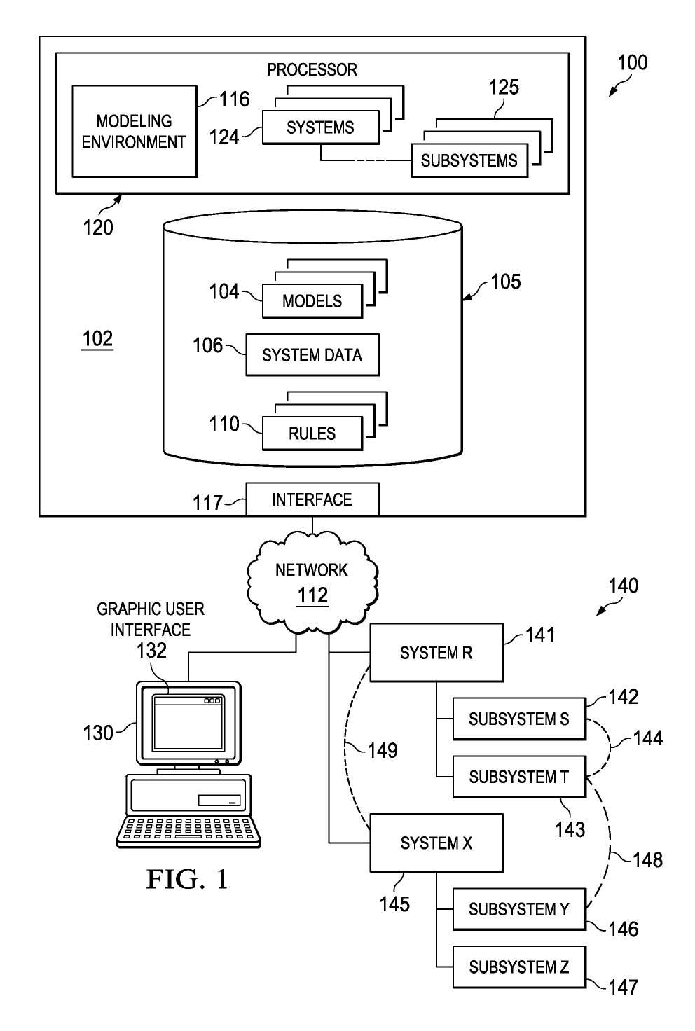

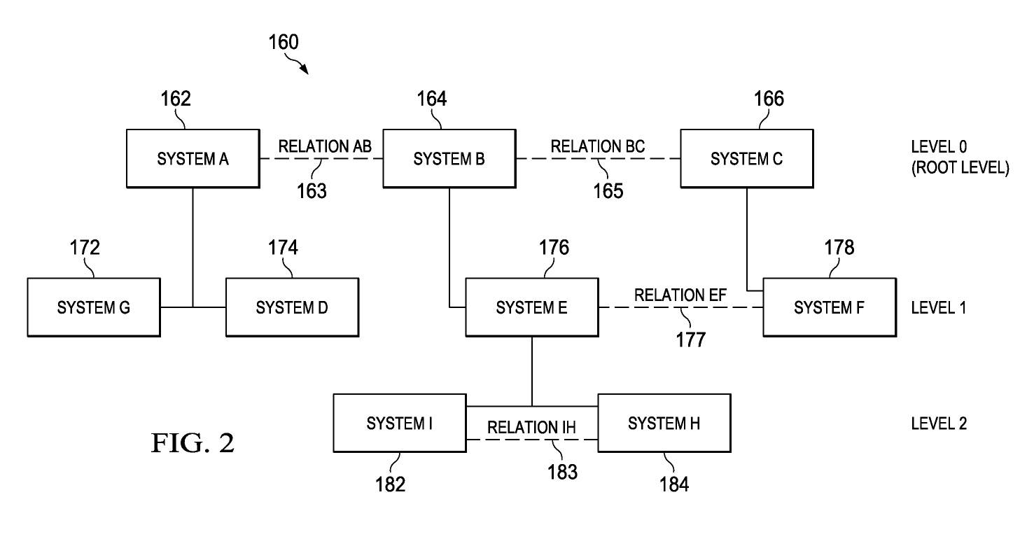

Turning to the illustrated example, FIG. 1 illustrates an example environment 100 for providing an interactive system landscape visualization. The illustrated environment includes, or is communicably coupled with, a server 102 and at least one client 130, at least some of which communicate across a network 112. In general, environment 100 depicts an example configuration of an organization of elements capable of storing information about a system. As mentioned briefly above, the term “system” may be defined as a technical, “integrated whole” software, hardware, or combined set of components. In some implementations, a system can be in the context of an elementary part of an IT operation. FIG. 2 is a schematic representation 160 of a system landscape organized in a subsystem hierarchy. In FIG. 2, the system 160 itself might consist of several subsystems (or, more generally, system components). Those system components are systems themselves, in the sense defined above. Therefore, the each system component can be visualized as a landscape and have relations to other system components. The relevance of the various system components may vary; therefore, the visual presentation may include an interaction model that takes the differences in the hierarchy level into account. Although the level of hierarchies is not restricted to a finite number, it will be assumed finite hereafter for illustrative purposes.

For example, in FIG. 2, the system 160 includes three tiers of hierarchy: Level 0 (root level), Level 1, and Level 2. This three-level system is, again, provided for illustrative purposes. The landscape visualization shows that the system 160 includes three system components in the root level: System A 162, System B 164, and System C 166. System A is shown as related to System B by Relation AB 163; likewise, System B 164 is related to System C 166 by Relation BC 165. System A includes two subsystems: System G 172 and System D 174. System B includes one related system in Level 2: System E 176. System C also includes one related system in Level 2: System F 178.

Returning briefly to Systems G 172 and D 174, these system components are in the Level 2 tier of the hierarchy. Systems D 174 and System G 172 are each shown to have no relationships with other system components (besides the parent/child relationship to System A). This visualization may indicate that no such relation exists; however, the absence of an illustrated relationship between System G 172 and System D 174 in a landscape visualization may be the result of the application of a filter to the data. As will be discussed in more detail below, the presentation of material may be customized to satisfy the user's criteria; likewise, the user may customize the visualization of information based on a scale of relevancy using a variety of graphical techniques (e.g., transparency, shading, colors, etc.). In this case, no relationship may exist or the relationship may be absent from the landscape visualization because, e.g., it may be irrelevant to what the user is interested in viewing.

As shown in FIG. 2, subsystems of disparate parent systems may be related. In this case, System E 176 is related to System F 178 by Relation EF 177. The cross-system relationship is visualized as part of the landscape. Similarly, subsystems of the same parent system may be related, and that relationship may be visualized. For example, System I 182 and System H 184 are related by Relation IH 183. Even though System I and System H share a parent system and are in the same hierarchical tier, a different relationship may exist between them that may be visualized as part of the landscape. Contrast System G 172 and System D 174, which also share a parent and are in the same hierarchical tier: in that case, the landscape visualization does not illustrate a relationship between the two. Again, the absence of the visualization of a relationship may indicate that no such relationship exists; or it may indicate that the user is not interested in visualizing whatever relationship does exist. In addition, although not shown, multiple relationships may exist between system components. The present disclosure provides for filtering of desired information and the customization of how desired information is to be visualized.

Returning to FIG. 1, a user operating a client device 130 may want to visually represent a system on graphical user interface (GUI) 132. System information may be acquired by accessing server 102. The systems 124 may be accessible to the user through server 102. Similarly, system data 106, stored on a repository 105 on server 102, may provide system information. For example, system data 106 may provide historical information about systems 124 and subsystems 125 for analytical purposes. In addition, system data 106 may be information about remote systems in communication with server 102. In that case, system data 106 may provide sufficient information to visualize the interactive landscape, or the system data 106 may be updated and synthesized upon request by the user.

An example of a remote distributed system 140 is shown in FIG. 1. System R 141 may include Subsystem S 142 and Subsystem T 143. System X 145 may include Subsystem Y 146 and Subsystem Z 147. System R 141 and System X 145 may be related by Relation RX 149. Subsystem S 142 and Subsystem T 143 may be related by Relation ST 144. Subsystem T 143 may be related to Subsystem Y 146 by Relation TY 148. In general, the distributed system 140 may be communicably coupled to server 102 across a network 112. Server 102 may access system 140 to provide system information to client device 130. In certain implementations, client device 130 may be communicably coupled directly with system 140 to receive information for landscape visualization. In other implementations, client device 130 may receive information about distributed system 140 without accessing server 102.

Returning to FIG. 1, the server 102 may be accessible by a user operating a client device 130. In this disclosure, the term user and client may be used interchangeably without deviating from the scope. The user may access information stored in a repository 105 on server 102 by a device 130 across a network 112. Information may be visually presented to the user on a graphical user interface (GUI 144). Though illustrated as a client/server configuration, it is to be understood that the server based processing and storage can be performed locally (e.g., at the client device 130). Similarly, even though a single server is illustrated, a distributed network environment may also be used. For example, the user may want to view information about a distributed system 140, which may be a system of hardware components, software components, or a combination. The user may use client device 130 to access information stored on each of the distributed hardware components across network 112. The information may be processed at different locations for viewing by the client; or the client may retrieve the data from a single point (server or local), where the landscape is visualized and provided to the user for viewing. Further, client device 130 may access information about the distributed system 140 through server 102 or from system 140 (e.g., across network 112).

Returning to the server 102 of FIG. 1, server 102 is any server that stores one or more systems 124. In some instances, requests and responses may also be received and/or sent between one or more clients, users, or entities not illustrated in FIG. 1. In general, the server 102 may be a part of a larger environment, and may in fact be represented as more than one server or system, with each portion performing a portion of the functionality described herein. In some instances, the server 102 may be a Java 2 Platform, Enterprise Edition (J2EE)-compliant application server that includes Java technologies such as Enterprise JavaBeans (EJB), J2EE Connector Architecture (JCA), Java Messaging Service (JMS), Java Naming and Directory Interface (JNDI), and Java Database Connectivity (JDBC). In some instances, the server 102 may store a plurality of systems 124 and subsystems 125. In some instances, the server 102 may comprise a web server or be communicably coupled with a web server, where the systems 124 represent, at least in part, one or more systems that may be monitored via network 112 by the client 130 of the system to perform the programmed tasks or operations of the visualization environment 152. Additionally, the server 102 may perform the operations associated with a modeling environment 116 used to provide models of system landscape for system landscape visualization, which may be based on system data 106, rules 110, or other visualization data/criteria.

At a high level, the server 102 comprises an electronic computing device operable to receive, transmit, process, store, or manage data and information associated with the environment 100. The server 102 illustrated in FIG. 1 can be responsible for receiving requests from client 130, responding to the received requests by processing said requests in the processor 120 and, in some instances, modeling environment 116, and sending the appropriate response back to the requesting visualization environment 152. Alternatively, server 102 can be capable of processing and responding to local requests from a user accessing the server 102 locally. Accordingly, in addition to requests from the clients 130 illustrated in FIG. 1, requests may also be sent from internal users, external or third-party customers, and other automated applications, as well as any other appropriate entities, individuals, systems, or computers.

As used in the present disclosure, the term “computer” is intended to encompass any suitable processing device. For example, although FIG. 1 illustrates the server 102 as a single server, environment 100 can be implemented using two or more servers for the server 102, as well as computers other than servers, including a server pool. Indeed, server 102 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated server 102 may be adapted to execute any operating system, including Linux, UNIX, Windows, Mac OS, or any other suitable operating system. According to one embodiment, the server 102 may also include or be communicably coupled with a mail server.

In the present implementation, and as shown in FIG. 1, the server 102 includes an interface 117, a processor 120, a memory 105, one or more systems 124 and, in some instances, one or more subsystems 125. The interface 117 is used by the server 102 for communicating with other systems in a client-server or other distributed environment (including within environment 100) connected to the network 112 (e.g., client 130, as well as other systems communicably coupled to the network 112, such as system 140). Generally, the interface 117 comprises logic encoded in software and/or hardware in a suitable combination and operable to communicate with the network 112. More specifically, the interface 117 may comprise software supporting one or more communication protocols associated with communications such that the network 112 or interface's hardware is operable to communicate physical signals within and outside the illustrated environment 100.

Although not illustrated in FIG. 1, the server 102 may also include a local user interface, such as a graphical user interface (GUI). The local GUI can comprise a graphical user interface operable to, for example, allow a local user of the server 102 to interface with at least a portion of the platform for any suitable purpose, such as creating, preparing, requesting, or analyzing data associated with the execution of a particular business application or information associated with a particular new or modified system and its visualization process. Generally, the local GUI provides the particular user with an efficient and user-friendly presentation of system data provided by or communicated within the system. The local GUI may comprise a plurality of customizable frames or views having interactive fields, pull-down lists, and buttons operated by the user. For example, the local GUI may provide interactive elements that allow a user to enter, select, create, or modify elements of business process instances or business object instances in the local GUI. More generally, the local GUI may also provide general interactive elements that allow a user to access and utilize various services and functions of visualization environment 152 and/or the modeling environment 116, including any modifications that may be made to new or modified implementations of business objects and other information associated with the systems 124 (and/or subsystems 124). The local GUI is often configurable, supports a combination of tables and graphs (bar, line, pie, status dials, or other tables and graphs), and is able to build real-time portals, where tabs are delineated by key characteristics (e.g., site or micro-site). Therefore, the local GUI contemplates any suitable graphical user interface, such as a combination of a generic web browser, intelligent engine, and command line interface (CLI) that processes information in the platform and efficiently presents the results to the user visually.

Example server 102 is communicably coupled with a network 112 that facilitates wireless or wireline communications between the components of the environment 100 (i.e., between the server 102 and one or more of clients 130), as well as with any other local or remote computer, such as additional clients, servers, or other devices communicably coupled to network 112 but not illustrated in FIG. 1. In the illustrated environment, the network 112 is depicted as a single network, but may be a continuous or discontinuous network without departing from the scope of this disclosure, so long as at least a portion of the network 112 may facilitate communications between senders and recipients. The network 112 may be all or a portion of an enterprise or secured network, while in another instance, at least a portion of the network 112 may represent a connection to the Internet.

In some instances, a portion of the network 112 may be a virtual private network (VPN), such as, for example, the connection between at least one of the clients 130 and the server 102. Further, all or a portion of the network 112 can comprise either a wireline or wireless link. Example wireless links may include 802.11/b/g/n, 802.20, WiMax, and/or any other appropriate wireless link. In other words, the network 112 encompasses any internal or external network, networks, sub-network, or combination thereof operable to facilitate communications between various computing components inside and outside the illustrated environment 100. The network 112 may communicate, for example, Internet Protocol (IP) packets, Frame Relay frames, Asynchronous Transfer Mode (ATM) cells, voice, video, data, and other suitable information between network addresses. The network 112 may also include one or more local area networks (LANs), radio access networks (RANs), metropolitan area networks (MANs), wide area networks (WANs), all or a portion of the Internet, and/or any other communication system or systems at one or more locations. The network 112, however, is not a required component of the present disclosure, such that some or all of the functionality may be performed locally at the server 102.

As illustrated in FIG. 1, the server 102 includes a processor 120. Although illustrated as a single processor 120 in FIG. 1, two or more processors may be used according to particular needs, desires, or particular embodiments of environment 100. Each processor 120 may be a central processing unit (CPU), a blade, an application specific integrated circuit (ASIC), a field-programmable gate array (FPGA), or another suitable component. Generally, the processor 120 executes instructions and manipulates data to perform the operations of the server 102. For example, processor 120 may receive a command from client 130 to provide a landscape visualization of, e.g., systems 124 and 125, to be presented GUI 132. Specifically, the server's processor 120 executes the functionality required to receive and respond to requests from the clients 130, as well as other functions.

Regardless of the particular implementation, “software” may include computer-readable instructions, firmware, wired or programmed hardware, or any combination thereof on a tangible and/or non-transitory medium operable, when executed, to perform at least the processes and operations described herein. Indeed, each software component may be fully or partially written or described in any appropriate computer language including C, C++, Java, Visual Basic, assembler, Perl, any suitable version of 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components, as appropriate.

At a high level, each of the one or more systems 124 (or 125) is any application, program, module, process, or other software that may execute, change, delete, generate, or otherwise manage information according to the present disclosure, particularly in response to and in connection with one or more requests received from the illustrated clients 130. In certain cases, only one system 124 may be located at a particular server 102. In others, a plurality of related and/or unrelated systems 124 may be stored at the server 102, or located across a plurality of other servers comprising the server 102, as well. For example, portions of the composite application may be implemented as Enterprise Java Beans (EJBs) or design-time components, and may have the ability to generate run-time implementations into different platforms, such as J2EE (Java 2 Platform, Enterprise Edition), ABAP (Advanced Business Application Programming) objects, or Microsoft's .NET, among others. Additionally, the systems 124 may represent web-based applications accessed and executed by remote clients, such as client 130, via the network 112 (e.g., through the Internet).

Further, while illustrated as internal to the server 102, one or more processes associated with a particular system 124 may be stored, referenced, or executed remotely. For example, a portion of a particular system 124 may be a web service associated with the application that is remotely called, while another portion of the system 124 may be an interface object or agent bundled for processing at a remote client 130. Moreover, any or all of the systems 124 and subsystems 125 may be a child, sub-module, or portion of another software module or enterprise application (not illustrated) without departing from the scope of this disclosure. Still further, portions of systems 124 (and subsystems 125) may be executed by a user or operator working directly, or locally, at the server 102, as well as remotely at client 130.

In general, server 102 may also include a memory 105. Memory 105 may include any memory or database module and may take the form of volatile or non-volatile memory including, without limitation, magnetic media, optical media, random access memory (RAM), read-only memory (ROM), removable media, or any other suitable local or remote memory component. Memory 105 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the server 102. Still further, while memory 105 is illustrated entirely within the server 102 in FIG. 1, some or all of the components illustrated in memory 105 may be stored external to the server 102 and/or to the illustrated environment 100 in some implementations.

In the example shown in FIG. 1, memory 105 stores system data 106. As discussed above, system data 106 may include information about systems 124 and subsystems 125 and/or may include information about system 140. System data 106 may be accessed and processed in response to a request to dynamically visualize the interested system. For example, system data 106 may include historical data about system 124, which may be used to identify differences or changes in the system. In addition, system data 106 may represent current data about the system after the request is made to visualize the system landscape. For example, processor 120 may process the request and retrieve system information, subsequently storing that information on memory 105.

In anticipation of landscape visualization, modeling environment 116 may be used to generate models 104 of system components. Models 104 of system components may be stored on memory 105. Such models 104 may be used to visualize the system landscape upon a request from a user. Modeling environment 116 may also generate models of system components upon request from a user to visualize the system landscape. Modeling environment 116 may generate visual representations of system components based on rules 110. Rule 110 may be used by modeler 116 to interpret a command (or other input) signal from the user to provide the user the appropriate level of detail for the system landscape visualization.

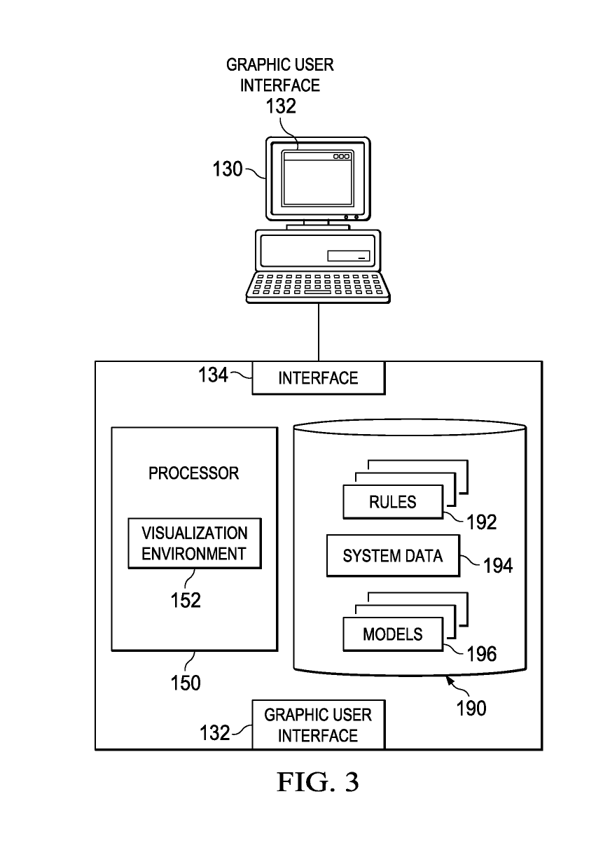

The illustrated environment of FIG. 1 also includes one or more clients 160. Each client 130 may be any computing device operable to connect to or communicate with the server 102, either directly or via the network 112 using a wireline or wireless connection. Turning briefly to FIG. 3, FIG. 3 is a schematic representation of a device for providing a user interface for an interactive system landscape visualization. Each client 130 includes an interface 134, a processor 150, a memory 190, visualization environment 152, and a graphical user interface (GUI) 132. In general, client 130 comprises an electronic computer device operable to receive, transmit, process, and store any appropriate data associated with the environment 100 of FIG. 1. It will be understood that there may be any number of clients 160 associated with, or external to, environment 100. For example, while illustrated environment 100 includes one client 130, alternative implementations of environment 100 may include a multiple clients communicably coupled to server 102, or any other number of clients suitable to the purposes of the environment 100. Additionally, there may also be one or more additional clients 130 external to the illustrated portion of environment 100 that are capable of interacting with the environment 100 via the network 112. Further, the term “client” and “user” may be used interchangeably as appropriate without departing from the scope of this disclosure. Moreover, while each client 130 is described in terms of being used by a single user, this disclosure contemplates that many users may use one computer, or that one user may use multiple computers. An example, a “user” may include an administrator or other IT professional monitoring a system landscape for software logistics change management.

The GUI 132 associated with client 130 comprises a graphical user interface operable to, for example, allow the user of client 130 to interface with at least a portion of the platform for any suitable purpose, such as creating, preparing, requesting, modifying, or analyzing data, as well as viewing and accessing documents and files associated with various business transactions. Generally, the GUI 132 provides the particular user with an efficient and user-friendly presentation of business data provided by or communicated within the system. The GUI 132 may comprise a plurality of customizable frames or views having interactive fields, pull-down lists, and buttons operated by the user. For example, GUI 132 may provide interactive elements that allow a user to enter or select elements of system models or instances and business objects associated with systems 124 and/or subsystems 125 in GUI 132.

Portions of the system 124 (and subsystems 125, as appropriate) associated with the server 102 may be presented and accessible to the user through GUI 132, such as through a web browser or visualization environment 152, for example. More generally, GUI 132 may also provide general interactive elements that allow a user to access and utilize various services and functions of visualization environment 152. The GUI 132 is often configurable, supports a combination of tables and graphs (bar, line, pie, status dials, etc.), and is able to build real-time portals, where tabs are delineated by key characteristics (e.g. site or micro-site). Therefore, the GUI 132 contemplates any suitable graphical user interface, such as a combination of a generic web browser, intelligent engine, and command line interface (CLI) that processes information in the platform and efficiently presents the results to the user visually. In some instances, visualization environment 152 may be a remote module, agent, or portion of the modeling environment 116 allowing users to access and modify data and values within the server 102, and in particular, data and values associated with systems 124 and subsystems 125.

In some instances, the visualization environment 152 may be a client application, may be a web-based application, or even a web browser, that can perform tasks other than those associated with the server 102. In some instances, the visualization environment 152 may be used by a remote administrator to initialize or interact with the server 102, such as to remotely initiate a visualization procedure on a particular business object associated with the server 102, as well as to define a time interval for performing verification procedures on one or more business objects.

A client device, such as device 130, may include at least one processor 150. Processor 150 may execute operations stored in memory 190 or stored in a remote memory or repository, such as a repository 105 associated with server 102. Memory 190 may store system data 106. System data 194 may be data associated with systems in communication with client device 130. System data 194 may be used to provide a user operating device 130 to visualize a system landscape. Memory 190 may also store models 196. Models 196 may be predefined visualization models of system data (such as system data 1946 or system data 106 stored on remote repository 105). In addition, memory 190 may include rules 192. Rules 192 may be used to define the level of detail and the content that is displayed based on a user input. Visualization environment 152 may receive and execute commands to provide a user with a visualization of the system landscape based on the system data 194 and/or models 196 or with the system data 106 and/or models 104 stored on remote repository 105 or based on some combination thereof.

As used in this disclosure, client 130 is intended to encompass a personal computer, touch screen terminal, workstation, network computer, kiosk, wireless data port, smart phone, personal data assistant (PDA), one or more processors within these or other devices, or any other suitable processing device. For example, each client 130 may comprise a computer that includes an input device, such as a keypad, touch screen, mouse, or other device that can accept user information, and an output device that conveys information associated with the operation of the server 102 (and systems 124 and subsystems 125) or the client 130 itself, including digital data, visual information, the visualization environment 152, or the GUI 132. Both the input and output device may include fixed or removable storage media such as a magnetic storage media, CD-ROM, or other suitable media to both receive input from and provide output to users of client 130 through the display, namely, the GUI 132.

While FIG. 1 is described as containing or being associated with a plurality of elements, not all elements illustrated within environment 100 of FIG. 1 may be utilized in each alternative implementation of the present disclosure. For example, although FIG. 1 depicts a server 102 external to network 112, the server 102, or a portion of the structure, systems, and functionality associated therewith, may be included within network 112 as part of a cloud computing network solution, for example. In some additional instances, the server 102 may be a set of servers or other systems that combine to perform the operations associated with the server 102 and the modeling environment 116. Additionally, the modeling environment 116 may be offered as a cloud-based solution, or distributed across one or more systems, including clients 130. Still further, one or more of the elements described herein may be located external to environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes, in addition to those purposes described herein.

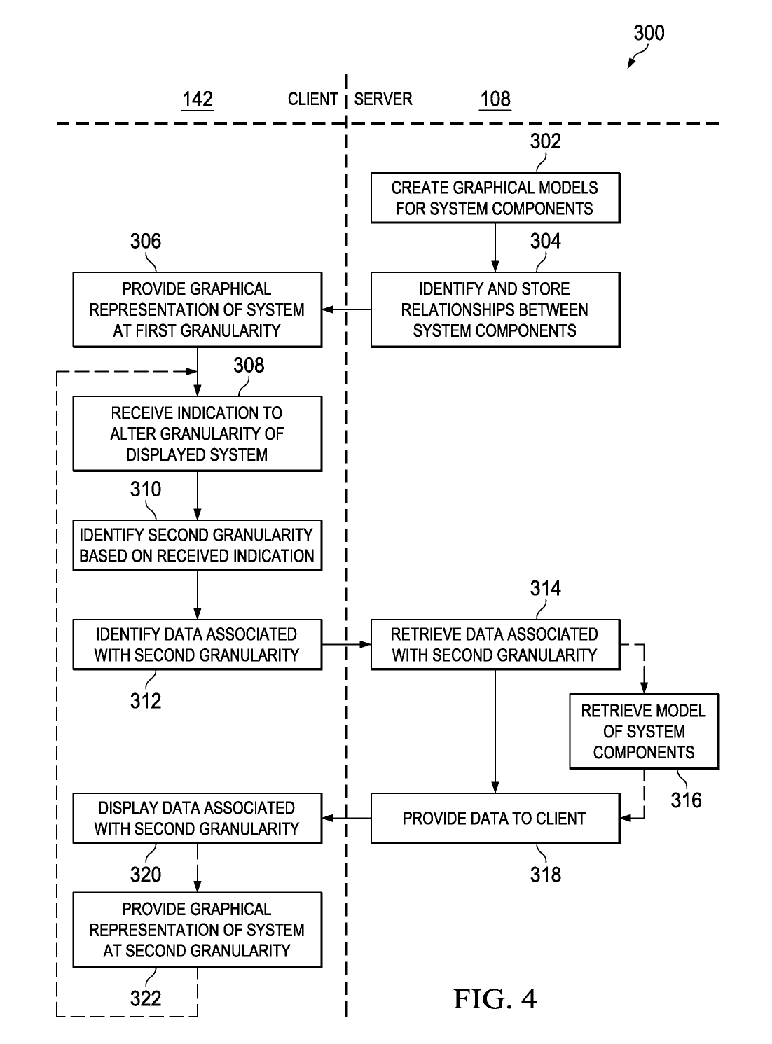

FIG. 4 is a swim-lane flowchart 300 of an example method for providing an interactive system landscape visualization. A graphical representation of a system landscape may be presented to a user (306). The landscape may be presented on a graphical user interface or by other techniques. The graphical user interface may permit a user to interact with the graphical presentation of the system landscape. A user may wish to alter the granularity (or detail level) of the system visualization by increasing the level of detail available for viewing and/or interaction. The user may provide an input to the graphical user interface to alter the granularity of the system visualization. The device may receive the indication from the user (308). The user may provide the request for a change in the visualization granularity by a user input device, such as a mouse or keyboard, or by using a touch screen device, such as a multi-touch device, or by other ways known to those of skill in the art. From a user experience perspective, a zoom-driven bird-eye metaphor can be implemented by using existing input paradigms like mouse scrolling or click-based focus gain. The distance between the user viewpoint (in the sense of computer graphics) and the landscape clipping can then be dynamically recalculated depending on the user interaction. Hence, the level of detail and sub-structure can be displayed accordingly.

Upon receiving an indication from a user to increase (or decrease) the granularity of the landscape visualization, a second granularity based on the received indication may be identified (310). The data associated with the second level of detail may be identified (312). In certain instances, the data associated with the second level of granularity may be received from a server (314). The data may also be located locally to the device. A graphical model may also be provided to the device (316). The model may be stored remotely (e.g., on a remote server) or locally. The data is provided to the client (318). The device may then provide the data associated with the second level of detail to the user (320). This providing may be in the form of a graphical representation for the second level of detail of the system landscape (322). Or it may provide data to the user in other forms, such as a status message or a message associated with software logistics (e.g., change management).

In certain implementations, graphical models may be created and stored in a repository associated with a server or a device (302). The graphical models may be called upon if a particular granularity is requested by the user. For example, in certain instances, the entire system landscape may be modeled prior to a user request for system landscape visualization. The models of various system components may be created, stored, and called upon a received indication from a user to visualize a particular system component. This may save time during runtime by providing an established model of the system to the user. The relationships between system components may be defined when the models are made (304). The relationships may play a role in defining how the visualization transitions between levels of granularity.

The granularity is associated with a certain level of detail of the system, that level of detail based on a number of factors. For example, the input from the user (e.g., a mouse wheel scroll indication) can determine the desired granularity the user wishes to visualize. Going further, the acceleration of the mouse wheel may determine the level of granularity. Likewise, a mouse wheel may step through the levels of granularity sequentially. The level of detail may vary based on user controlled or developer controlled parameters. For example, as a user increases the level of detail, the lower level details may disappear, become increasingly opaque as higher levels of detail are displayed, or may be provided by other unobtrusive graphical ways.

An intuitive visualization of hierarchal landscapes may take into account that not all levels of information and, therefore, levels of hierarchies, are relevant in all cases. A natural starting point could be the lowest, or root level (level in the hierarchy where no system is a sub-system of any other system). An increase in the detail level can then be achieved by applying a zoom-like metaphor: by decreasing the distance to a given landscape element, more and more details and hierarchal information become visible. To enable a smooth adaption, the visibility is calculated continuously and updated in real time. Therefore, the user experiences a birds eye-like zoom-in and can focus on the relevant parts in any given context.

In certain instances, the actual visibility and size of an object (system or relation) can be derived from the calculated distance between the viewpoint origin and the object. The visibility of an object can be adapted by adjusting the alpha value of the graphic objects (0≦a≦1). The value of alpha in the color code ranges from 0.0 to 1.0, where 0.0 represents a fully transparent color, and 1.0 represents a fully opaque color. Let d be the current distance to a system or relation with level l in a landscape (e.g., hierarchical distance) with maximum viewpoint distance dₘₐₓ, a minimum distance to the object dₘᵢₙ and maximum sub-system level lₘₐₓ, the actual visibility of the object can then be determined by various algorithms. In general, the aforementioned variations of alpha adjustment may fulfill the following example conditions:

For l=0: a=1
The mapping (l,d)_{object}→a is smooth
For every level 0≦l≦lₘₐₓ exists a distance d₀ with dₘᵢₙ≦d₀≦dₘₐₓ where a=1 and for d<d₀: a<1.

The latter concept may not exclude the possibility of alpha values decreasing again after a=1 was already reached. Hence, visualizations may also be created where already shown detail may vanish again. This notion not only facilitates a decrease in the complexity of a visualization for end users, but can also be motivated quite naturally: if an observer gets close enough to a real-world object, more and more details are perceptible. Further implementations may permit loose oversight regarding the whole object. From a user interface perspective, this opens the possibility to present the useful information to the end user—the details can be visually more prominent then the objects with a lower level (by having lower alpha values for lower level objects). The present disclosure provides examples to outline the ideas described above.

The systems, program products, and methods described herein are not limited to 3-dimensional visualizations, but can also be applied to 2-dimensional representations of a landscape by introducing an additional third spatial component in z-direction (the surface normal of the 2-dimensional drawing plain). In such a case the actual calculation of distance becomes trivial, since it is proportional to the z-component.

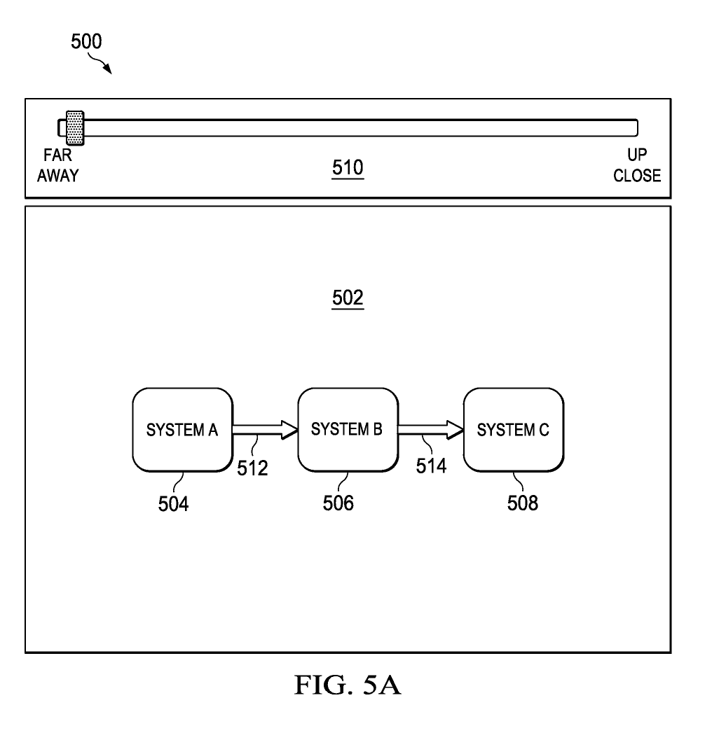

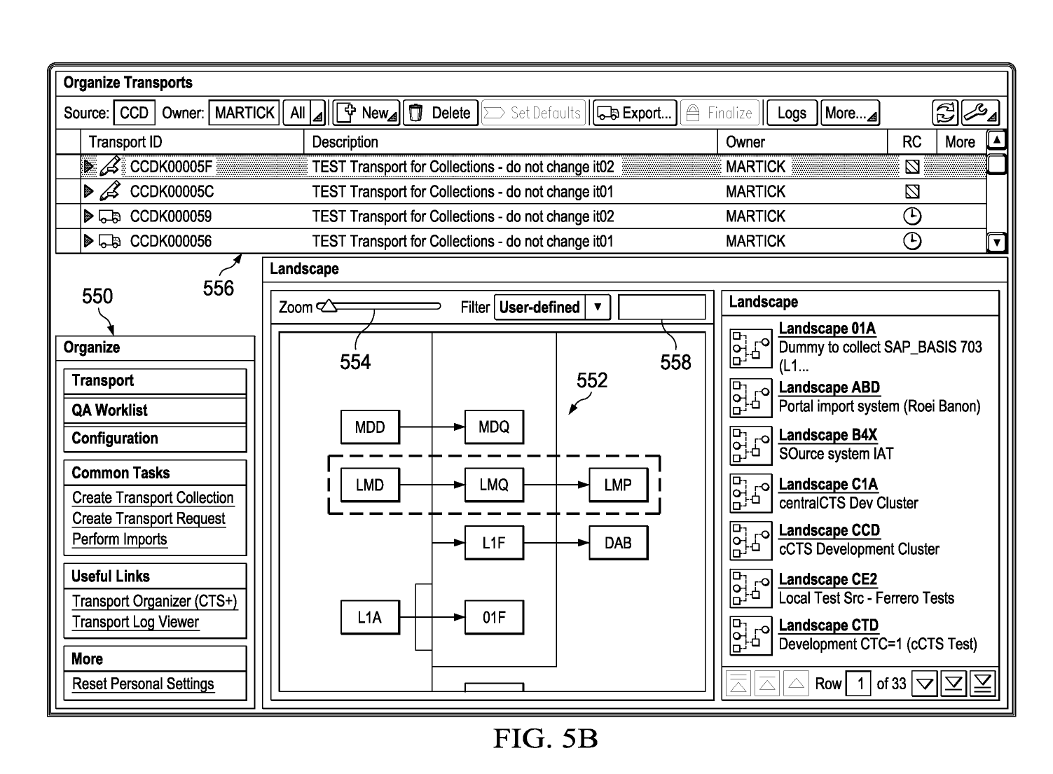

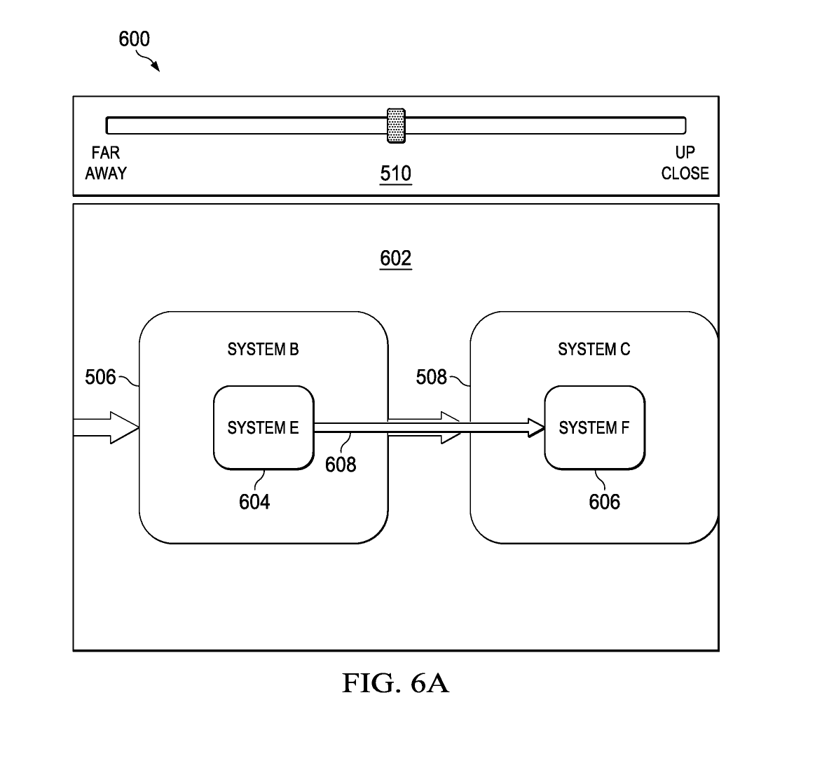

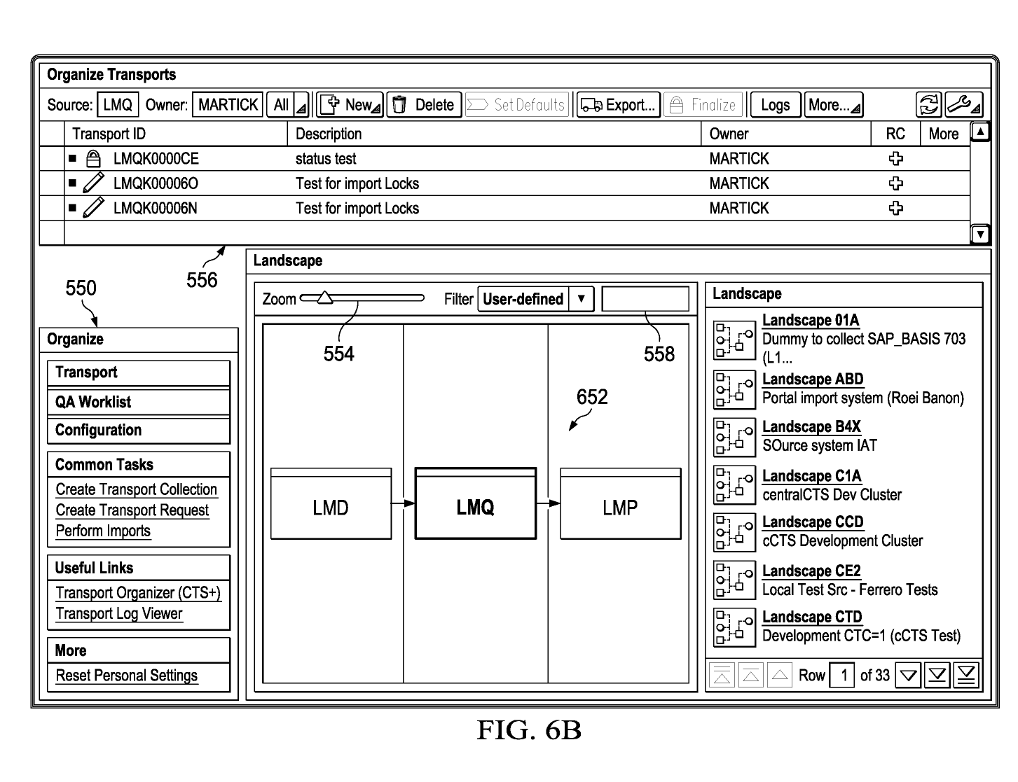

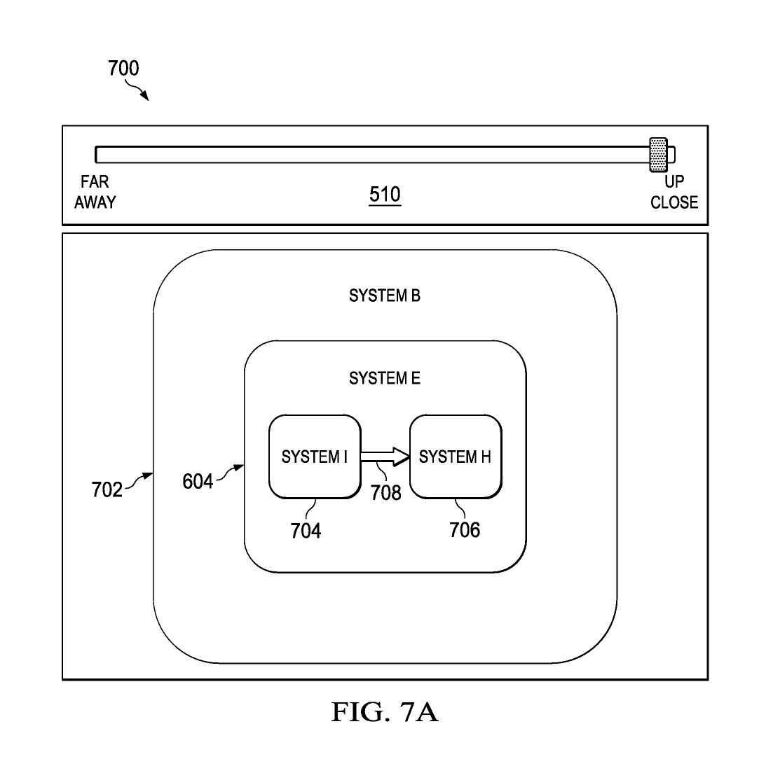

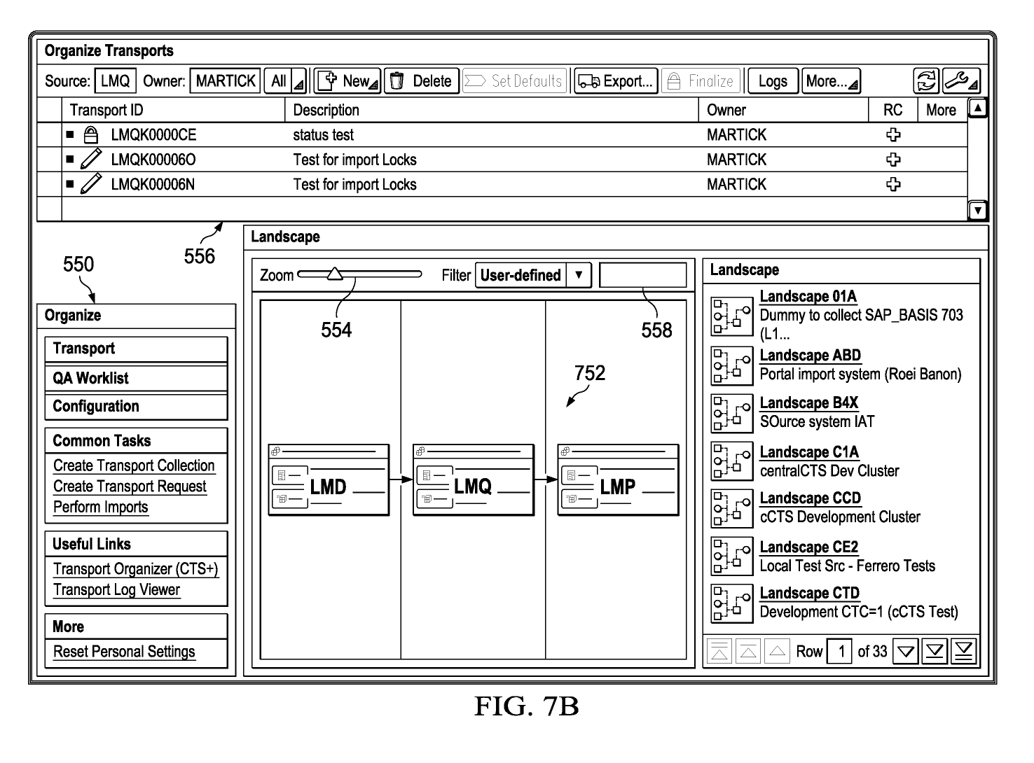

A 2-dimensional visualization can be enhanced with a trivial z-axis in such a way, that the user viewpoint is fixed on this axis regarding the x and y coordinates. Then, a top-down visualization may be implemented by adjusting the scale of the objects in the plain and applying alpha values as mentioned before. For the sake of this example, let us assume a landscape as shown in FIG. 2. A schematic landscape visualization UI can be found in FIGS. 5-8. In the provided examples and figures, systems are visualized by rounded rectangles and system relations by the directed arrows. The initial screen offers the user an overall landscape view. The actual user interaction—a zoom in/out and move around the actual view frame—is described in the text associated with FIGS. 6 and 7.

FIG. 5A is a schematic representation of a low detail level system landscape visualization 500. As an example starting point, the user sees the initial (root level) landscape 502 with systems and relations. In this example, systems are visualized by rounded rectangles and the relations are displayed as directed arrows. The user can move around the landscape using click/drag metaphors, as well as by other known interface techniques. The user can zoom in by using a slider UI element 510, a (mouse) scroll gesture, a (multi) touch gesture, or similar interaction methods. In FIG. 5A, the slider 510 is in the “Far Away” position, which, in this implementation, corresponds to the visualization that provides the lowest level of detail.

In FIG. 5A, System A 504, System B 506, and System C 508 make up the landscape visualization. The relationships between the systems are also visualized. Here, System A is related to System B by a relation AB 512; similarly, System B is related to System C by relation BC 514. FIG. 5A is referred to as providing low level detail because the landscape visualization provided in FIG. 5A shows the lowest amount of details in the example landscape. FIG. 5B is a screenshot of an example implementation of a low detail level system landscape visualization 550. In FIG. 5B, the system landscape 552 is visualized at a low detail level. The “zoom” slider 554 may be used by a user to change (in this case, increase) the level of detail provided in the visualization. The user may also view data 556 associated with the system landscape. A user may enter user defined filter criteria for the system visualization in, e.g., a text bar 558. The criteria may be used to provide the user with particular information in the landscape visualization.

As mentioned above, a user may want to increase the level of detail in the visualization. The user may “zoom” down into the visualization to view more details pertaining to a particular system or set of systems. FIG. 6A is a schematic representation of an intermediate detail level system landscape visualization 600. Here, system landscape 602 includes System B 506 and System C 508. System B 506 includes Subsystem E 604 and System C 508 includes Subsystem F 606. (Recall that subsystems are also systems in and of themselves.) In addition, a relation 608 is shown between Subsystem E and Subsystem F. The slider 510 is in an intermediate position. FIG. 6B is a screenshot of an example implementation of an intermediate detail level system landscape visualization 550. Systems 652 (here, LMD LMQ and LMP) are presented with a higher level of detail with respect to both the substantive content associated with each system and the relationships between the systems.

The user performs a zoom action and makes the first level hierarchy visible. In addition, moving around the landscape puts the focus on the correct system location. Level zero objects slowly fade out (lower alpha value). First level objects (systems and relations) become visible. The user can focus on the detail level and still put them into the right (parent) context. It should be noted that even though other systems are not visible, in some implementations, a user may pan (upwards or downwards) to view other systems within the same hierarchy or within a predefined set of filters or user implemented criteria.

FIG. 7A is a schematic representation of a high detail level system landscape visualization 700. FIG. 7A illustrates a graphical visualization window 702 that interactively displays system information to a user operating user device 130. System E 604 may include two or more subsystems, such as Subsystems I 704 and Subsystem H 706. Subsystems I and H may be related by relation 708. The slider 510 is in an “Up Close” position. A user may zoom in and out of System E to view subsystem I and subsystem H. For example, the user may place a mouse cursor or pointer “above” System I and scroll the mouse wheel to zoom into System I. The user may then scroll the mouse wheel in the opposite direction to zoom out of System I and visualize System E. The user may then place the mouse pointer over system H and zoom into system H.

FIG. 7B is a screenshot of an example implementation of a high detail level system landscape visualization. In FIG. 7B, systems 752 (here, LMD, LMQ, and LMP) are presented with an increased amount of detail. In FIG. 7B, the substantive content associated with the systems is presented with the inter-system relationships.

The user may perform a zoom action and make the highest hierarchy level visible. Again, moving around the landscape puts the focus on the right clipping. Level zero objects are not visible anymore, first level objects slowly fade out (lower alpha value). Second level objects (systems and relations) are fully visible. The user can focus on the highest detail level and still recognize the context.

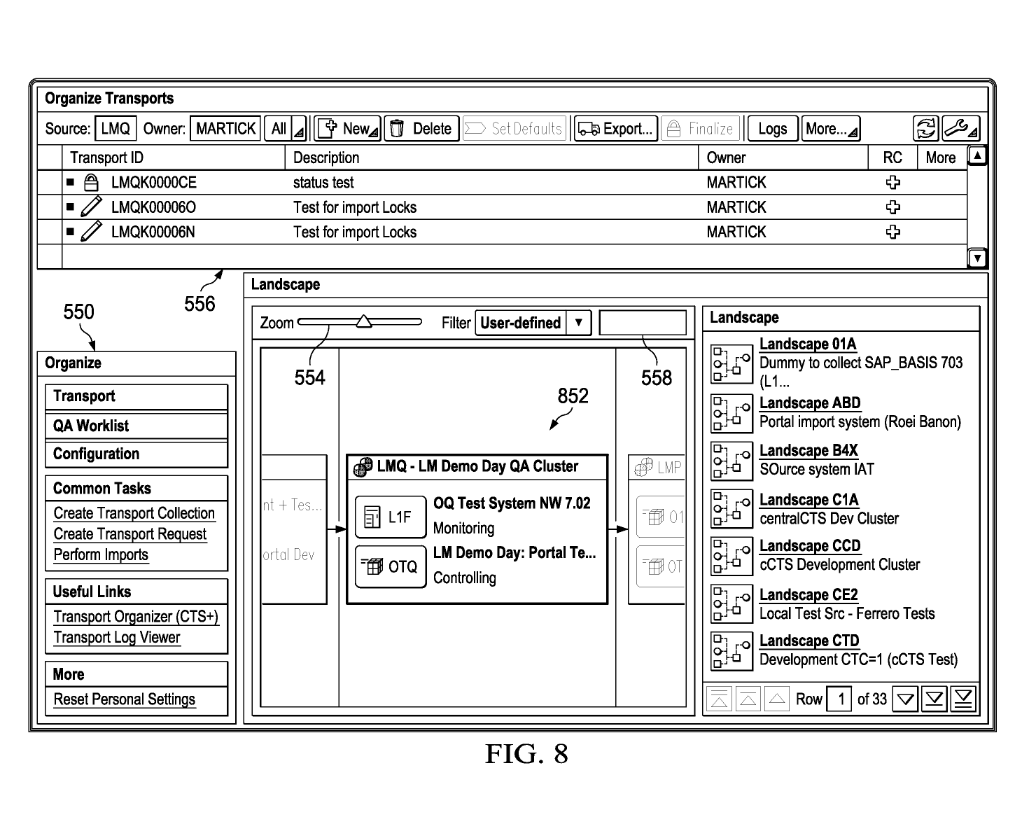

FIG. 8 is a screenshot of an example implementation of a high detail level system landscape visualization. In FIG. 8, the subsystems are shown with an even higher level of detail. In this case, data associated with substantive content is presented for each of the subsystems 852. Further, subsystems are also shown (L1F, OTQ for system LMQ).

The preceding figures and accompanying description illustrate example processes and computer implementable techniques. But environment 100 (or its software or other components) contemplates using, implementing, or executing any suitable technique for performing these and other tasks. It will be understood that these processes are for illustration purposes only and that the described or similar techniques may be performed at any appropriate time, including concurrently, individually, or in combination. In addition, many of the steps in these processes may take place simultaneously, concurrently, and/or in different orders than as shown. Moreover, environment 100 may use processes with additional steps, fewer steps, and/or different steps, so long as the methods remain appropriate.

In other words, although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. A computer-implemented method performed by one or more processors for providing visual representations of a system, the method comprising:
displaying a first visual representation of the system, the first visual representation providing a first level of detail of at least one first system component;
receiving an indication from a user to display a second visual representation of the system;
determining, by a processor, a second level of detail of the system based on the received indication;
identifying data associated with the second level of detail of the system; and
displaying the second visual representation of the system, the second visual representation of the system including the data associated with the second level of detail of the system.

2. The method of claim 1, wherein the first visual representation of the system components is a two-dimensional graphical representation of the system components.

3. The method of claim 1, wherein displaying the second visual representation of the system includes displaying at least one second system component, the at least one second system component associated with the data associated with the second level of detail of the system.

4. The method of claim 1 further comprising receiving data associated with the second level of detail for the system components from a remote server.

5. The method of claim 1, further comprising graphically transitioning between the first visual representation and the second visual representation, wherein the graphical transitioning is based on a predefined set of rules associated with the received indication.

6. The method of claim 5, wherein graphically transitioning between the first visual representation and the second visual representation is based on a hierarchical distance between the at least one first system component and the at least one second system component.

7. The method of claim 5, wherein the transitioning between the first visual representation and the second visual representation is based on a first color value associated with the first visual representation and a second color value associated with the second visual representation.

8. The method of claim 7, wherein the first and second color values each include a range of values, each of the range of values representing a relative opacity of a color, and wherein the graphical transitioning between the first visual representation and the second visual representation includes calculating the first color value for the first visual representation based on a hierarchical distance between the at least one first system components and the at least one second system components.

9. The method of claim 7, wherein the color value is a function of the relative distance between hierarchical levels of the system.

10. The method of claim 9, wherein the color value results in a maximum color opacity at a root level of the landscape hierarchy.

11. The method of claim 9, wherein the color value results in a less than maximum color opacity

12. The method of claim 1, wherein receiving an indication from the user to display the second visual representation of the system includes receiving an input from a user interface.

13. A computer program product tangibly embodied on a non-transient computer readable medium for providing visual representations of a system, the computer program product storing instructions operable when executed by a hardware processor to:
display a first visual representation of the system, the first visual representation providing a first level of detail of at least one first system component;
receive an indication to display a second visual representation of the system;
identify a second level of detail of the system based on the received indication;
identify data associated with the second level of detail of the system; and
display the second visual representation of the system, the second visual representation of the system including the data associated with the second level of detail of the system.

14. The computer program product of claim 13, wherein the first visual representation of the system components is a two-dimensional graphical representation of the system components.

15. The computer program product of claim 13, wherein displaying the second visual representation of the system includes displaying the data associated with the second level of detail of the system as a graphical representation of the system components.

16. The computer program product of claim 13 further operable to receive data associated with the second level of detail for the system components from a remote server.

17. A system for providing landscape visualization about a computer architecture landscape, the system comprising:
a memory for storing instructions and computer architecture landscape visualization data; and
at least one hardware processor, operable to execute the instructions to:
store computer architecture landscape visualization data, the computer architecture landscape organized into a hierarchy having a plurality of hierarchical tiers including a root level tier and at least one sub-level tier, the computer architecture landscape visualization data including data associated with the root level tier and the at least one sub-level tier;
receive a request from a client device to provide the landscape visualization of at least one of the plurality of tiers of the computer architecture hierarchy;
identify, based on the received request, the at least one of the plurality of tiers of the computer architecture hierarchy;
identify a set of the computer architecture landscape visualization data for the at least one of the plurality of tiers; and
provide the set of the computer architecture landscape visualization data to the client device.

18. The system of claim 17 wherein the set of the computer architecture landscape visualization data is an interactive graphical representation of the at least one of the plurality of tiers of the computer architecture landscape.

19. The system of claim 18 wherein the interactive graphical representation of the at least one of the plurality of tiers of the computer architecture landscape is identified based on an input provided by the client device.

20. The system of claim 17 further operable to identify and store relationships between the root level and the one or more sub-levels of the tiered hierarchy system.
